(19) United States
(12) Patent Application Publication
(10) Pub. No.: US 2005/0011520 A1
(43) Pub. Date: Jan. 20, 2005

(54) Medical tank strap system

(76) Inventor: James A. Rowe, Kalispell, MT (US)

Correspondence Address: Antoinette M. Tease, P.L.L.C., PO Box 51016, Billings, MT, 59105, US

(21) Appl. No.: 10/620,164

(22) Filed: Jul. 14, 2003

(51) Int. Cl. A62B 7/00; A62B 9/00

(52) U.S. Cl. 128/205.22

(57) ABSTRACT

A human-carried portable medical tank assembly includes a tank in a tank-holding assembly, such as a pouch. A shoulder strap is attached to the tank-holding assembly. At least a portion of the strap is configured to flex during movement of the human carrier of the tank-holding assembly to such a degree that the perceived weight of the tank and tank-holding assembly is lessened.

### FIELD OF THE INVENTION

The present invention relates portable medical gas administration systems, particularly to portable oxygen systems.

### BACKGROUND OF THE INVENTION

The administration of gases such as oxygen for therapeutic purposes has long been known. Presently, there are a variety of systems used for the storage and delivery of oxygen. A first example uses compressed oxygen cylinders known as “green tanks”, which are usually large tanks or “H tanks” delivered to the patient's home and secured in a safe corner of a room. Portable smaller units are used for transport, including wheel-carried “E” tanks as well as “A”, “B”, “C”, and “D” tanks, which are commonly shoulder-carried.

An alternative system uses oxygen concentrators, which concentrate oxygen from the air and deliver it to the patient. Until recently, oxygen concentrators were usually not portable, and still require electricity to work. Patients using oxygen concentrators typically have portable E tanks on hand to be used for backup in case of power failure. Oxygen concentrators are often used for individuals who are on oxygen only at night, but can be used 24 hours per day.

A more recent and relatively costly development is the use of liquid oxygen systems, which usually consist of a large silver main tank and one or two portable units. The portable units are used as needed for travel outside of the home. When they are empty, they can be refilled from the large tank. Portable units usually weigh four to ten pounds and can be carried with a shoulder strap or cart.

Patients requiring long-term oxygen therapy (LTOT) are often in an acute or chronic weakened state. Their very condition makes it difficult for them to carry relatively heavy tanks, thus making it difficult for such patients to use portable oxygen systems. This can result in the patient feeling housebound, which may worsen the patient's physical and psychological condition and hamper recovery or wellness.

In an attempt to ameliorate such a situation, various oxygen tank carrying systems have been developed. For example, U.S. Pat. No. 6,003,704 to Culjak is directed to a lumbar supported carrier for oxygen tanks including a main belt portion and a pouch for the tank. The belt has a shoulder strap for stabilizing the belt and tank extending over the shoulder and diagonally across the body. The shoulder strap comes with a series of smaller straps for securing the hose or cannula that is used in connection with the tank. The pouch is attachable to the belt by means of straps and has a drawstring with cord lock for securing the tank within the pouch. In addition, the pouch has separate D rings that allow the pouch to be attached to the shoulder strap and used separately from the belt. The belt has a padded portion to fit the curve of the lumbar area of the human spine.

An example of “backpack” oxygen carrying system is shown in U.S. Pat. No. 5,400,934 to Ducros, in which a rucksack, or backpack is adapted to make it possible to drink, or inhale oxygen, whilst walking. The rucksack includes two straps wherein at least one of its two straps defines a protective, isothermic inner space, for example by means of a foldable protective band which is sewn on the upper half of the strap. A recipient is placed in the rucksack and its tube passes in this protective space and finally terminates in a valve for drinking or inhaling.

An example of a strap system in a different context can be seen in U.S. Pat. No. 6,471,105 to Ammerman, which shows a shoulder carrier having at least one shoulder strap connected to a container. A lumbar support attached to the container bears on a wearer's hip or lumbar spine to transfer weight of the shoulder carrier to the hip or lumbar spine and away from the wearer's shoulder. The shoulder strap can include a shoulder pad, and both the shoulder pad and lumbar support can be or include a fluid-filled bladder. The shoulder pad can be slidably attached to the shoulder strap to prevent abrasion of the wearer's shoulder. At least one end of the shoulder strap can be attached to the container by passing the strap through a guide attached to the container and attaching the shoulder strap end to the container at a position below the guide.

Despite the advantages of known carrying systems, it can be seen that the need exists for a simple, inexpensive, system for effectively and efficiently securing a medical gas delivery system to a patient in order to reduce perceived weight of the system.

### SUMMARY OF THE INVENTION

These and other objects are achieved by providing a human-carried portable medical tank assembly including a tank in a tank-holding pouch. A shoulder strap is attached to the pouch. At least a portion of the strap is configured to flex during movement of the human carrier of the tank assembly to such a degree that the perceived weight of the tank is lessened.

The features of the invention believed to be patentable are set forth with particularity in the appended claims. The invention itself, however, both as to organization and method of operation, together with further objects and advantages thereof, may best be understood by reference to the following description taken in conjunction with the accompanying drawings.

### BRIEF DESCRIPTION OF THE DRAWINGS

FIG. 1 is a schematic perspective view of a tank assembly embodying the principles discussed herein.

FIG. 2 is a detailed sectional view of a strap used in the FIG. 1 assembly.

FIG. 3 is a schematic perspective view of a tank assembly in accordance with the principles of the present invention using an alternative strap attachment.

FIG. 4 is a schematic perspective view of a tank assembly in accordance with the principles of the present invention using another alternative strap attachment.

### DETAILED DESCRIPTION OF THE INVENTION

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

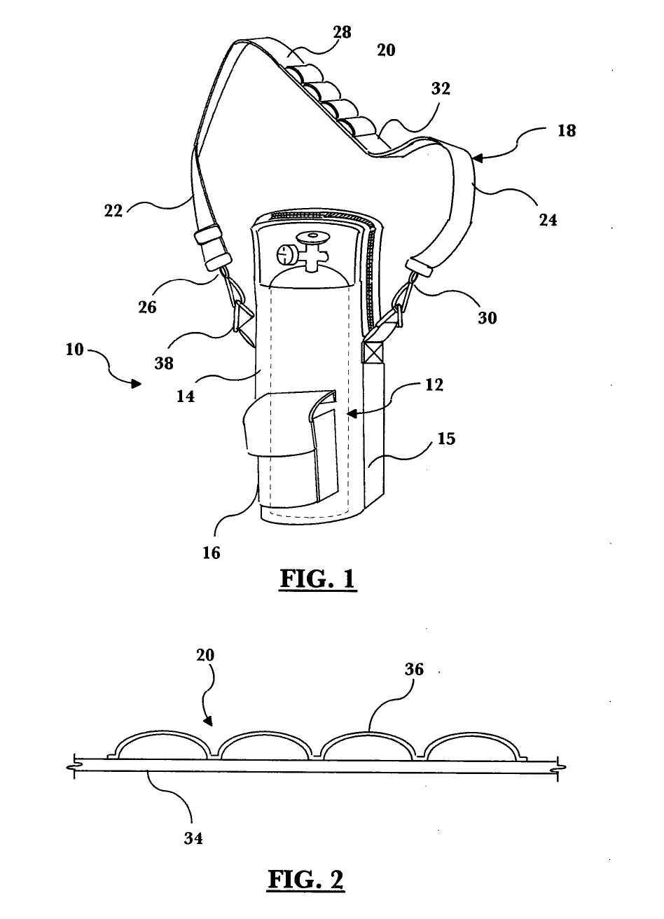

A tank assembly 10 constructed in accordance with the principles of the present invention is shown in FIG. 1. The tank assembly 10 includes a tank 12 containing a therapeutic fluid, such as oxygen. Although the tank 12 is illustrated as a type “B” tank, the principles of the present invention are equally applicable to any mechanism for providing therapeutic fluid in a gaseous or liquid state. This would encompass any size, standard or custom, or pressurized gas tank, as well as tanks and systems for holding therapeutic fluid in liquid form for delivery to the patient as a gas, such as liquid oxygen systems.

The tank 12 is contained in a tank-holding assembly 14. The tank-holding assembly 14 is configured as a pouch 15 dimensioned to fit the tank 12, and can include additional features to accommodate accessories or guide tubes or cannula for use with the tank 12. Although illustrated as a pouch 15, it is contemplated that the tank-holding assembly 14 can be provided as a rigid or semi-rigid housing surrounding a source of therapeutic fluid, or even as “ears” secured to opposite sides of an outer tank. In FIG. 1, a pocket 16 is provided to hold cannulae, masks, and the like. The pouch 14 can be fabricated from any suitable material. Such pouches are conventionally constructed from a fabric such as nylon, but it is contemplated that a pouch fabricated from a material such as neoprene would be advantageous.

A shoulder strap assembly 18 is attached to the pouch 14. The strap assembly 18 is configured to flex during movement of a human carrier of the tank assembly 10 to such a degree that the perceived weight of the tank 12 is lessened. Examples of suitable straps can be seen in U.S. Pat. No. 4,924,557 to Heckerman and U.S. Pat. No. 4,976,388 to Coontz, and U.S. Pat. No. 5,695,102 to Jackson, the specifications of which are incorporated by reference herein. It is to be understood that the strap 18 is merely illustrative, and that any strap meeting the requirements of the present invention can be employed.

The strap assembly 18 is constructed as a multi-element strap having a flexible section 20 flanked by a pair of structural sections 22, 24. In the illustrated example, the structural sections 22, 24 are fabricated from a material that has less “give” than the material from which flexible section 20 is made.

The first structural section 24 has a first end 26 secured to the tank pouch 14 and a second end 28 secured to the flexible section 20. The second structural section 22 has a first end 30 secured to the tank pouch 14 and a second end 32 secured to the flexible section 20.

As shown in FIG. 2, the flexible section 20 includes a flexible element 34 and an adjustably structural element 36 secured to the flexible element 34. The structural element 36 is longer than the flexible element 34, and is secured in overlaying relation to the flexible element 34. The flexible element can be configured from a suitable flexible material such as neoprene, and the structural element can be fabricated from a material such as cordura nylon.

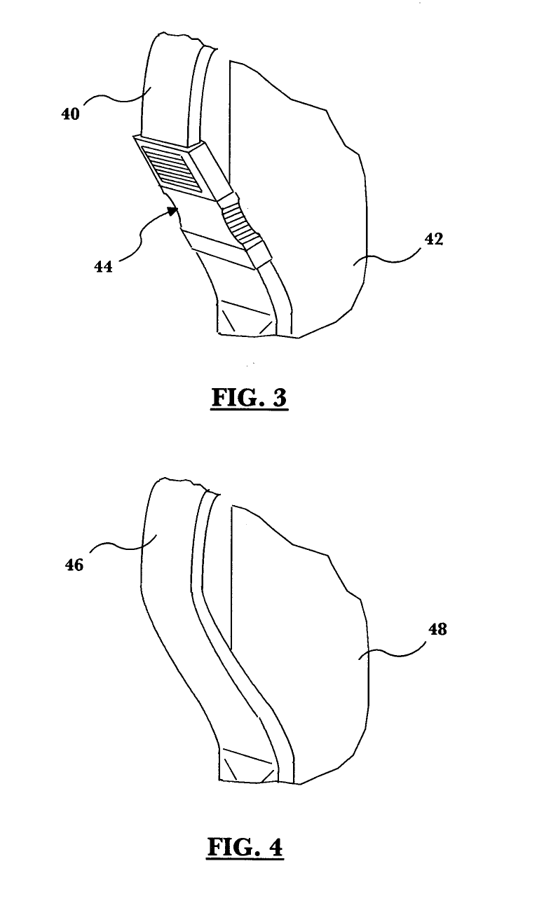

In FIG. 1, the strap assembly 18 is attached to the pouch 14 via spring clips 38. It is contemplated that the strap 18 can be secured by any suitable mechanism. For example, FIG. 3 shows a strap 40 secured to a pouch 42 via parachute buckles 44, and FIG. 5 shows a strap 46 sewn directly to a pouch 48.

The present invention is illustrated in the context of a single-shoulder-strap arrangement. However, it is also contemplated that the principles of the present invention are equally applicable to dual-strap, or “rucksack”-type arrangements.

Although the present invention has been described with reference to specific embodiments, those of skill in the art will recognize that changes may be made thereto without departing from the scope and spirit of the invention as defined by the appended claims.

1. A human-carried portable medical tank assembly comprising the following:
a tank;
a tank-holding assembly; and
at least one shoulder strap attached to the pouch, with at least a portion of the strap being configured to flex during movement of the human carrier of the tank assembly to such a degree that the perceived weight of the tank is lessened.

2. A tank assembly according to claim 1, wherein the at least one strap comprises a multi-element strap.

3. A tank assembly according to claim 2, wherein the strap further comprises the following:
a flexible section; and
a first structural section having a first end secured to the tank pouch and a second end secured to the flexible section; and
a second structural section having a first end secured to the tank pouch and a second end secured to the flexible section;
whereby the structural sections are fabricated from a material that has less “give” than the material from which flexible section is made.

4. A tank assembly according to claim 3, wherein the flexible section comprises the following:
a flexible element having a first length; and
a structural element secured to the first flexible element and having a second length, with the second length being greater than the first length.

5. A tank assembly according to claim 4, wherein the flexible element is secured in overlaying relation to the structural element.

6. A tank assembly according to claim 5, wherein the flexible element is fabricated from neoprene.

7. A tank assembly according to claim 1, wherein the a tank-holding assembly comprises a pouch fabricated from neoprene.

8. A human-carried portable medical fluid assembly comprising the following:
a source of therapeutic liquid;
a source-holding assembly adapted and constructed to contain the source of therapeutic fluid; and
a shoulder strap attached to the a source-holding assembly, with at least a portion of the strap being configured to flex during movement of the human carrier of the source-holding assembly to such a degree that the perceived weight of the source-holding assembly is lessened.

9. A medical fluid assembly according to claim 8, wherein the strap comprises a multi-element strap.

10. A medical fluid assembly according to claim 9, wherein the strap further comprises the following:
a flexible section; and
a first structural section having a first end secured to the source-holding assembly and a second end secured to the flexible section; and
a second structural section having a first end secured to the source-holding assembly and a second end secured to the flexible section;
whereby the structural sections are fabricated from a material that has less “give” than the material from which flexible section is made.

11. A medical fluid assembly according to claim 10, wherein the flexible section comprises the following:
a flexible element having a first length; and
a structural element secured to the first flexible element and having a second length, with the second length being greater than the first length.

12. A medical fluid assembly according to claim 11, wherein the flexible element is secured in overlaying relation to the structural element.

13. A medical fluid assembly according to claim 12, wherein the flexible element is fabricated from neoprene.

14. A medical fluid assembly according to claim 8, wherein the source-holding assembly comprises a pouch fabricated from neoprene.

15. A method for carrying a portable medical tank assembly, the method comprising the following steps:
providing a tank containing a therapeutic liquid;
placing the tank in a tank-holding assembly adapted and constructed to contain the tank;
attaching a shoulder strap to the tank-holding assembly, with at least a portion of the strap being configured to flex during movement of the human carrier of the tank-holding assembly to such a degree that the perceived weight of the tank and tank-holding assembly is lessened; and
securing the strap to the shoulder of a user.

16. A method according to claim 15, wherein the step of providing a strap comprises providing a multi-element strap.

17. A method according to claim 16, wherein step of providing a strap further comprises the following:
providing a flexible section;
securing a first end of a first structural section to the tank-holding assembly;
securing a second end of a first structural section to the flexible section;
securing a first end of a second structural section to the tank-holding assembly; and
securing a second end of the second structural section to the flexible section;
whereby the structural sections are fabricated from a material that has less “give” than the material from which flexible section is made.

18. A method according to claim 17, wherein the flexible section comprises the following:
a flexible element having a first length; and
a structural element secured to the first flexible element and having a second length, with the second length being greater than the first length.

19. A method according to claim 18, further comprising securing the flexible element in overlaying relation to the structural element.

20. A method according to claim 15, further comprising providing the tank-holding assembly as a pouch fabricated from neoprene.
